(19) United States
(12) Patent Application Publication
(10) Pub. No.: US 2008/0210374 A1
(43) Pub. Date: Sep. 4, 2008

(54) Performance Enhancing Attachment for Sports Equipment

(75) Inventor: Joseph S. Yatsko, Hinckley, OH (US)

Correspondence Address: D.A. STAUFFER PATENT SERVICES LLC, 1006 MONTFORD ROAD, CLEVLAND HTS., OH, 44121-2016, US

(73) Assignee: Yatz Co., Inc.

(21) Appl. No.: 11/996,291

(22) PCT Filed: Jul. 13, 2006
(86) PCT No.: PCT/US06/27406

§ 371 Date: Jan. 18, 2008

Related U.S. Application Data
(60) Provisional application No. 60/700,170, filed on Jul. 18, 2005.

(51) Int. Cl. B32B 7/12

(52) U.S. Cl. 156/327

(57) ABSTRACT

A performance enhancing attachment and method of performance enhancement for sports equipment that includes a high performance plastic layer and an adhesive on one surface of the plastic layer for attaching it to the equipment. Preferably the adhesive is an aggressive, high-tack resilient adhesive; and plastic is a long chain, high density polymeric UHMW plastic. When applied to a board member surface the plastic enhances slipperiness and resists board breakage and delamination. Using a plastic and adhesive that are substantially transparent enables viewing of graphics that are protectively covered by the attachment. Making the plastic layer relatively thin and flexible enables its use in a wide range of creative equipment enhancements by an end user. A particularly advantageous use is for protecting and enhancing slipperiness of the bottom of a skateboard deck or a wheel truck.

### CROSS-REFERENCE TO RELATED APPLICATIONS

This application claims the benefit of U.S. Provisional Patent Application No. 60/700,170 filed Jul. 18, 2005 by Yatsko.

### TECHNICAL FIELD OF THE INVENTION

The present invention relates to sliding surfaces of sports equipment and, more particularly to attachments that enhance sliding characteristics of said equipment, most particularly for wheeled sports equipment such as skateboards and roller skates.

### BACKGROUND OF THE INVENTION

Skateboarding (often abbreviated as “skating”) has advanced from a simple recreational activity to a very rigorous sport involving stunts (tricks) that place serious if not extreme demands on the skateboarding equipment. Referring to the illustrations of FIGS. 1A-5 herein, the skateboard (or simply the “board”) 10 comprises a platform (“deck”) 12 for standing on, and two pairs of wheels 16 attached to the bottom 13b of the deck 12. The two wheels 16 in each pair are mounted on an axle 24 protruding from the two sides of a “truck” 22 that is attached to the deck 12. Bearings 17 between the wheel and the axle (e.g., ball bearings) are used to minimize frictional drag on the wheel. More generally, the truck 22 is whatever structure rollingly attaches one or more wheels 16 to the rest of the equipment, i.e., the deck 12. On a skateboard 10 the truck 22 includes provision for tilting and/or rotating the axle 24 relative to the deck 12 to enable the skateboard 10 to turn. The deck 12 has a top 13a and bottom surface (face) 13b, side edges, a nose (in front) 14a and a tail (in back) 14b. On current boards 10 used for tricks, the deck's nose 14a and tail 14b are virtually the same shape and size such that the board 10 can be ridden in either direction. Virtually the entire bottom surface 13b and uncovered portions of the top surface 13a of the deck 12 are usually embellished with colorful graphics 20 according to the taste of the skater.

One example of extreme demands on the equipment is a “slide” (see FIGS. 2-3) wherein a skater rides along a raised surface (e.g., rail 100, wall 102) by positioning the skateboard 10 so that a portion (e.g., nose 14a) of the board's deck (generally the bottom face 13b but could also be an edge or even the top face 13a) slides along the raised surface 100, 102 instead of rolling on the wheels 16. This means that the deck 12 rubs against metal bars, rails, benches, concrete barriers, stone curbs, right angle wall edges, etc. In order to slide farther and faster, skaters may use wax or some other lubricant on the deck 12, on the raised surface (e.g., 102) or on both for reducing friction to enhance the gliding effect. Of course sliding will quickly cause both the lubricant and the graphics 20 to be damaged and worn away. With increased wear, the deck 12 itself can be damaged. It should be apparent that a board 10 with a new coat of lubricant has a different slipperiness (“slide feel”) than one where the lubricant is wearing off, and the slide feel continues to change when the lubricant is gone and the board 10 is sliding on a coat of varnish or paint or graphic decal. Of course the slide feel becomes even worse when the deck surface finish is rubbed away and the board 10 is sliding on bare or roughened wood. As a result, skateboards 10 are typically replaced rather frequently, particularly when used in competition. And the modern, high tech skateboard can be very expensive.

“Grinding” is another skateboarding trick that is very hard on the equipment (see FIG. 4). Like sliding, grinding is when the skater rides along a raised surface (e.g., a rail 100) by positioning the skateboard 10 so that either or both of the trucks 22 slide along the raised surface instead of rolling on the wheels 16. Again, reduced friction and minimized wear damage are highly desirable. The terms “grinding” and “sliding” are sometimes used interchangeably, particularly by those less familiar with the sport, such that either term can be considered a generic term for the action of riding along a surface on any part of the skateboard 10 other than the wheels 16.

Another demand on skateboards 10 is a result of jumping (doing an “ollie”). Not only must the deck 12 resist breaking or delaminating when the skater on the skateboard drops down from an elevation to a lower level, but the deck 12 must also be springy so that the deck 12 can be impacted for bending it downward and then unweighted such that it springs upward to rise with the skater when he/she jumps. It is highly desirable to both improve breakage/delamination resistance and to increase the springiness (“pop”) of the deck 12.

A common problem with skateboards 10 when they are used for jumps or hard turns is “wheel bite”, illustrated at location 200 in FIG. 5. This occurs when the deck 12 is tilted so much relative to the truck 22 that the wheel 16 on one side of the truck 22 rubs against the bottom 13b of the deck (e.g., at location 200). The increased friction on only one portion of the board 10 can cause slowing at best, and falls in worst cases.

Serious skaters generally customize their skateboards 10 to meet their own performance needs and preferences, as well as their personal tastes in appearance. The first step is to select a deck 12. Because there are at least ten different size/shape variations and more than fifty factory applied graphics and colors, very few stores will have a stock of every possible combination of size, shape, color and graphic design. And of course there are also different manufacturers to consider and different board construction materials used. Thus the deck 12 is generally ordered from a catalog rather than purchased off a store shelf. Usually a “grip tape” material 18 is applied (usually self-adhered) to at least a portion of the top 13a of the deck to provide a non-slip surface for the skater to stand on. The grip tape 18 may be already applied by the deck 12 manufacturer to fit in with the graphics, or else it can be done when the skateboard 10 is being assembled. The trucks 22 and wheels 16 must also be selected from a range of sizes, manufacturers, materials, performance and quality levels. Generally the trucks 22 are attached to the deck 12, each with four screws, and the wheels 16 with ball-bearing 17 sets are attached to the truck axles 24 using a nut tightened onto the threaded end of the axle. The selected combination of skateboard components can be ordered from a catalog to be assembled by the catalog company or can be obtained from possibly multiple sources and then assembled by the skater or by a retail assembler of made-to-order skateboards 10.

Screw holes and screws in the deck 12 affect both the strength and the pop of the deck 12, therefore it is desirable to minimize the number and size of screws in screw holes drilled into the deck 12. It is also desirable to minimize the weight of the skateboard 10.

Typical skateboard materials include painted laminated wood for the deck 12 (e.g., 7 layers of hardwood glued together), and aluminum, steel or various alloys for the trucks 22. Besides wax and lubricant, it is known to apply a varnish-like coating of polyurethane on the deck 12 as a protective and somewhat slippery layer (clear so that graphics 20 under the coating are visible). The grip tape 18 is a sheet or ribbon of material that has a non-slip surface (e.g., sandpaper-like) on one side and an adhesive backing on the reverse side. It can be cut to a desired size and shape and adhered to the top of a deck 12 by a skater or by a retail assembler. Generally speaking the grip tape 18 is a “post production” component, i.e., a component that is applied after production of a completed skateboard deck—after lamination, cutting, shaping and surface finishing (e.g., paint and/or varnish). Graphics 20 may be applied as part of the deck production process, but it is more efficient to apply them post production upon receiving an order for a given deck/graphic combination.

Current wheel bearing 17 technology is primarily based on steel or ceramic ball bearings. Common disadvantages to the use of these current offerings include: corrosion that results in poor performance or seizing failures; contamination degradation due to particulate matter entering the bearing 17 and causing excessive wear, drag, or catastrophic failure; excessive drag due to normal wear or misalignment of bearing sets 17 in the wheel; and a need for excessive maintenance.

Various additional components are or have been available for post production customizing of skateboards 10, many of them designed to protect parts of the board 10 and/or to increase the slipperiness of the deck bottom 13b. “Rails” or “rib bones” are narrow plastic strips that are attached under the deck 12 along the edges. Similarly a “jaw bone” is a plastic strip shaped in an arc to attach around the bottom of the nose 14a, and a “tail bone” or “tail guard” is a strip that can be attached under the back edge of the tail 14b. All of these “bones” have fallen out of favor because of various disadvantages: they add to the weight, they are attached with screws or nails, and they are relatively thick, e.g., as much as a half inch thick. Thick side ribs interfere with turns, and thick tail or jaw bones reduce the amount of height that is obtainable in performing an ollie. An example of a tail guard is the skid pad (39) disclosed in U.S. Pat. No. 6,074,271 (Derrah; 2000). Derrah's skid pad is made of UHMW (ultra high molecular weight) plastic and appears to be fairly thick as illustrated in Derrah's FIGS. 1 and 2.

The prior art also includes some devices (“copers”) for increasing slipperiness and wear resistance of the skateboard trucks 22 while grinding. Again there are problems that have made the devices unpopular: generally they wear out quickly, and are tedious to replace. For example, U.S. Pat. No. 6,648,372 (Ojeda; 2003) discloses a skateboard truck guard comprising a sheet of material that is formed into a guard body (20) that is appropriately shaped for wrapping around the axle-holding “hanger” portion of the truck. The guard body is preferably made of a durable material such as alloy, polyurethane, or fiberglass for providing a predetermined friction, and is securely attached to the truck by fastening elements (30) such as zip-ties, loop-shaped clips or durable wires. Another example, U.S. Pat. No. 6,945,542 (Stewart; 2005) discloses a skateboard truck shield comprising a discrete sheet of material (preferably UHMW polyethylene) that has a smooth, low-friction surface and is formed to encircle portions of the truck assembly so as to hold the sheet of material in a fixed position underlying and covering the lower surface of the truck with the smooth, low-friction surface directed downwardly. The shield (15) has a first hole (54) adjacent one end of the truck shield body positioned to encircle the pivot strut (25) and two additional holes (51, 52) adjacent an opposite end of the shield body positioned to encircle the mounting post (40). Thus the truck assembly must be disassembled and reassembled in order to attach Stewart's shield. Another example, U.S. Pat. No. 6,648,345 (Lee; 2003) discloses an anti-wear strip equipped wheel seat of skateboard. The strip (12) is made of a “wear resistant material” and appears to be some type of metal that covers the bottom of the truck (11) to provide an anti-wear face. The strip is U-shaped such that “end edges are embedded along with the axle (13) in the main body” of the truck. Presumably the truck must be replaced when the embedded anti-wear strip wears out.

Tricks such as sliding and grinding that were initially developed by skateboarders have been adapted for use with related sports equipment such as scooters, rollerblades, roller skates, inline skates, and trick bikes. For example, Stewart '542 mentions that his truck shield can protect surfaces between wheels on in-line skates and the like. For example, trick bikes have rod-like pegs extending laterally outward from the bike sides (e.g., outward from a wheel axle). Although the pegs are intended for standing on by the bike rider, the bike can also be caused to slide or grind by riding the bike on a peg sliding along a surface instead of riding on a rolling wheel.

It is an object of the present invention to provide skateboard components that enhance performance properties including sliding, grinding, weight reduction, and wear/damage protection.

It is a further object that the inventive components be suitable for simple post-production customizing of skateboards.

It is a further object to apply the teachings of the invention to related sports equipment.

### BRIEF SUMMARY OF THE INVENTION

According to the invention a performance enhancing attachment for sports equipment is provided, the attachment comprising: a high performance plastic layer; and an adhesive on one surface of the plastic layer for adhering the plastic to the equipment.

Preferably the adhesive is an aggressive, high-tack adhesive; and the adhesive is resilient.

Preferably the plastic is UHMW plastic.

Preferably the plastic and the adhesive are substantially transparent.

Preferably the plastic is 0.005 to 0.030 inch (0.13-0.76 mm) thick, and more preferably is about 0.020 inch (0.51 mm) thick.

Preferably the plastic layer is suitable for adhering to the entire bottom surface of a skateboard deck.

Optionally the plastic layer incorporates graphics.

According to the invention a method is provided for enhancing sliding performance of sports equipment surfaces that are not originally intended for sliding use, the method comprising the steps of providing a wear resistant, low friction material in the form of a relatively thin and flexible sheet; and supplying a resilient, aggressive, high-tack adhesive layer on a surface of the sheet material.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “islices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIGS. 1A, 1B and 1C are side, top, and bottom views, respectively, of a prior art skateboard;

FIG. 2 is a view of a skateboarder sliding on a nose portion of the skateboard along a raised surface;

FIG. 3 is a side view of a skateboard in position for sliding on a rail;

FIG. 4 is a side view of a skateboard in position for grinding on a rail;

FIG. 5 is a front view of a skateboard wherein the deck is tilted as in a hard turn that causes a wheel to contact the deck;

FIG. 6A is a perspective view of a roll of plastic with adhesive and liner paper, according to the invention;

FIG. 6B is a magnified edge view of the circled part of FIG. 6A, showing the plastic, adhesive and paper layers, according to the invention;

FIGS. 7A and 7B show skateboard bottom surfaces that have plastic adhered to the surface in alternative ways, according to the invention;

FIGS. 8A and 8B show a perspective view and a side, partially cross-sectioned view, respectively, of a skateboard wheel truck with a plastic layer being applied thereto according to the invention;

FIG. 9 shows a bottom view of an inline skate with alternative forms of plastic layers adhered thereto according to the invention;

FIGS. 10A and 10B show side and bottom views, respectively, of a shoe with a plastic layer adhered thereto according to the invention; and

FIGS. 11A and 11B show distant and close side views, respectively, of a stunt bike sliding on a rail with a plastic layer advantageously adhered to a peg of the bike according to the invention.

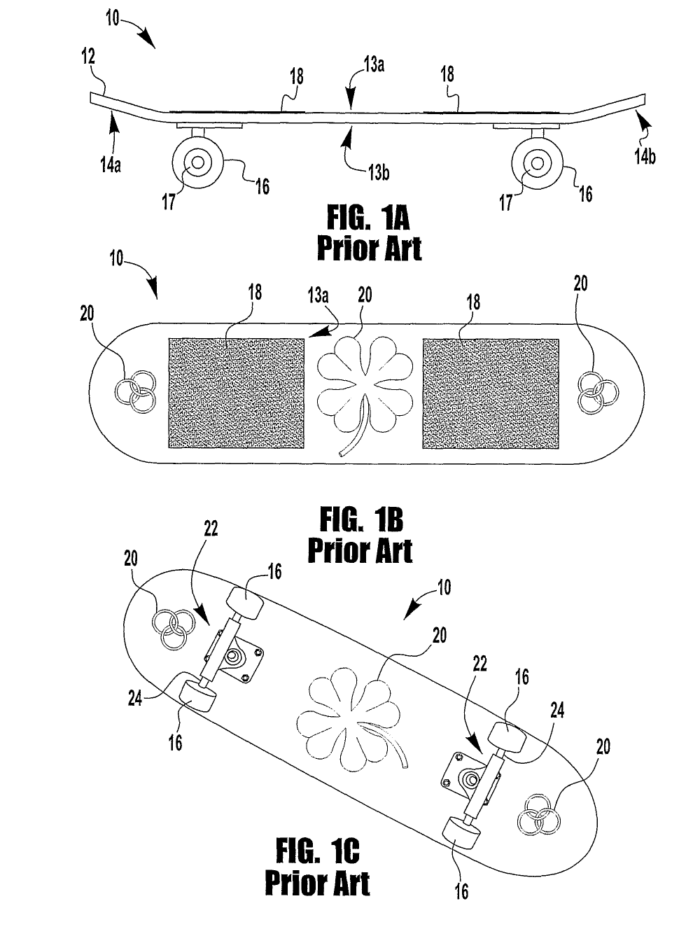

### DETAILED DESCRIPTION OF THE INVENTION

The use of plastic in industrial applications has provided many benefits throughout recent years. Numerous industrial components have been replaced with, or have been improved through the use of, “engineered polymers” due to the identification and implementation of their unique characteristics such as wear resistance, low coefficient of friction, and endurance in harsh environments. Plastics can be used in places that traditional materials such as metal or wood simply can not perform, or deteriorate quickly in use. Catastrophic failures and undesirable operating behaviors can be minimized or even eliminated in many applications through the use of appropriate plastics.

Plastics provide reductions in friction that can significantly enhance performance, increase life and maintain high levels of performance without the need for service or maintenance over the life of the product, for example a wheel bearing 17.

The time has come to apply the advanced polymer sciences to recreational skating devices such as skateboards 10, rollerblades (e.g., skate 30 in FIG. 9), and scooters, as well as to related sports equipment.

Utilizing plastics/polymers such as Acetals (Delrin), Acrylic, CPVC, EVA, FEP Fluoropolymers, Fiberglass-FRP, Garolite®, G10/FR4 Phenolics, HDPE, HIPS-Polystyrene, Kevlar, LDPE, LLDPE-Linear Low, MDPE, Noryl®, Nylon, Nylatron®, PBT, PEEK, PETG, PFA-Fluropolymer, Polycarbonate, Polyimide, Polypropylene, Polystyrene, Polysulfone/Ultem, Polyurethane-TPU, PTFE, PVC, PVDF, Santoprene®, Teflon®, Torlon®, Tygon®, UHMW, UHMWPE, Ultem®, PEI, Versilic®, Zelux®, and others can provide enhancements in the current offerings for scooter, skate, and skateboard bearings 17, skid plates, and graphics protectors. A preferred type of plastic for practicing this invention is a long chain, high density plastic, e.g., UHMW, however all suitable advanced polymers will be referred to generically herein as “plastic”.

Bearings

Current wheel bearing 17 technology is primarily based on steel or ceramic ball bearings. Common disadvantages to the use of these current offerings include:
a. Corrosion that results in poor performance or seizing failures,
b. Contamination degradation due to particulate matter entering the bearing 17 and causing excessive wear, drag, or catastrophic failure,
c. Excessive drag due to normal wear or misalignment of bearing sets 17 in the wheel,
d. The need for excessive maintenance.

Replacing ball bearings 17 in skate wheels 16, 34 with solid plastic bearings 17 can provide performance advantages as well as eliminate all of the above disadvantages found in the current steel or ceramic ball bearing 17 offerings.

These advantages may take many forms that utilize polymers such as multipart plastic bearings 17, multipart plastic and metal bearings 17, and polymer coatings on metal, plastic, or other materials that are made to act as a bearing 17 and utilize the advantageous properties of plastic for this application. In one embodiment, the entire wheel 16, 34 is made of a selected plastic that has no bearings 17 installed. In this case, the wheel 16, 34 is the bearing 17. The wheel 16, 34 can have other materials molded to or affixed to it for appearance or added performance.

The inventor has made and tested various prototypes that use these methods in different embodiments. Various aspects of performance, bearing life, and quality are being perfected in order to produce the best range of product offerings as replacements to the existing steel and ceramic ball bearings 17.

Boards

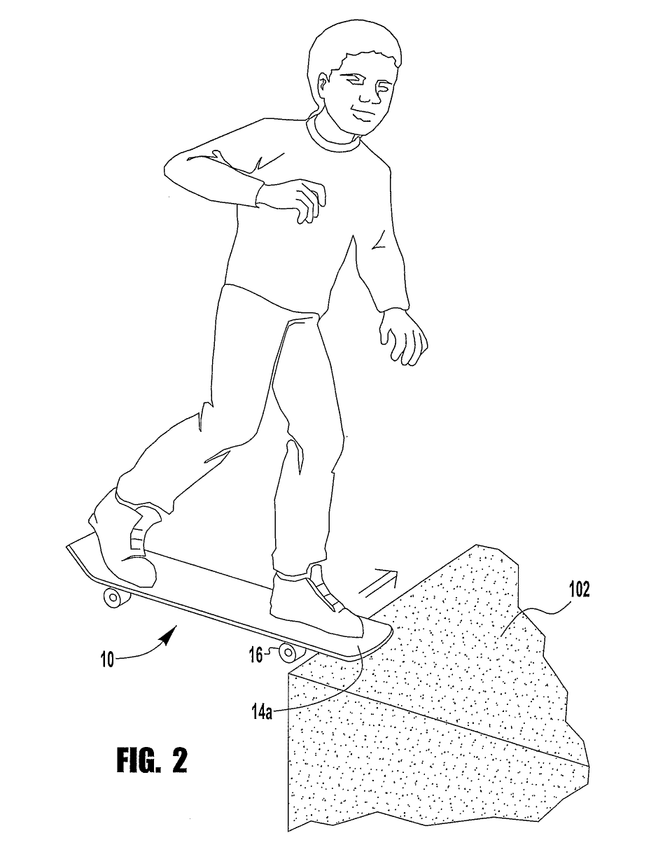

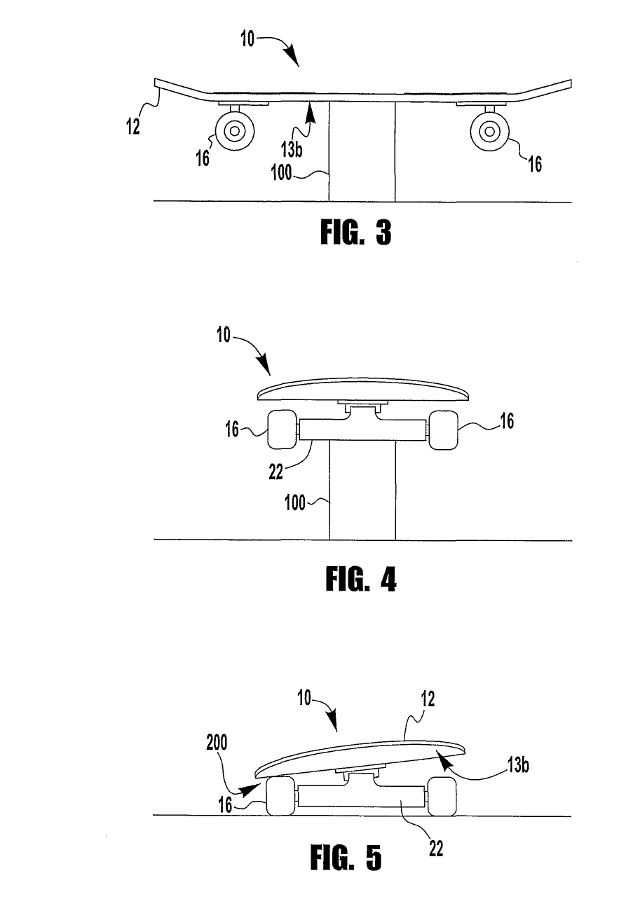

Skateboards 10 are embellished with colorful graphics 20; however, as described above with reference to FIGS. 2 and 3, even when using wax or some other lubricant, sliding tricks quickly cause the graphics 20 on the sliding surface (e.g., bottom 13b) of the boards 12 to be damaged or completely worn away. The present invention involves placing a relatively thin (e.g., 0.005-0.100 inch, 0.13-2.5 mm thick) sheet 42 of plastic on the bottom of the board, thereby significantly enhancing the glide effect without the use of additional lubricants, and also protecting the underlying graphics 20, e.g., with the use of substantially transparent (“clear”) plastic sheet 42. “Substantially transparent or clear” means that the graphics 20 can be seen through the material, therefore the terms encompass translucent material that is thin enough to allow satisfactory viewing of the graphics 20. The invention also involves providing the thin plastic sheet material 42 with a pre-applied coating of adhesive that enables self-adherence of the plastic 42 to surfaces such as the bottom 13b of the deck 12. The adhesive is preferably an aggressive, high tack adhesive, most preferably one that is substantially clear in thin layers. An off-the-shelf example of a suitable adhesive is the “superstick” rubber based adhesive used on Avery #8345 double coated polyester tape (Avery Dennison; Painesville, Ohio, USA). It will be seen that a resilient adhesive such as a rubber based one provides some advantages.

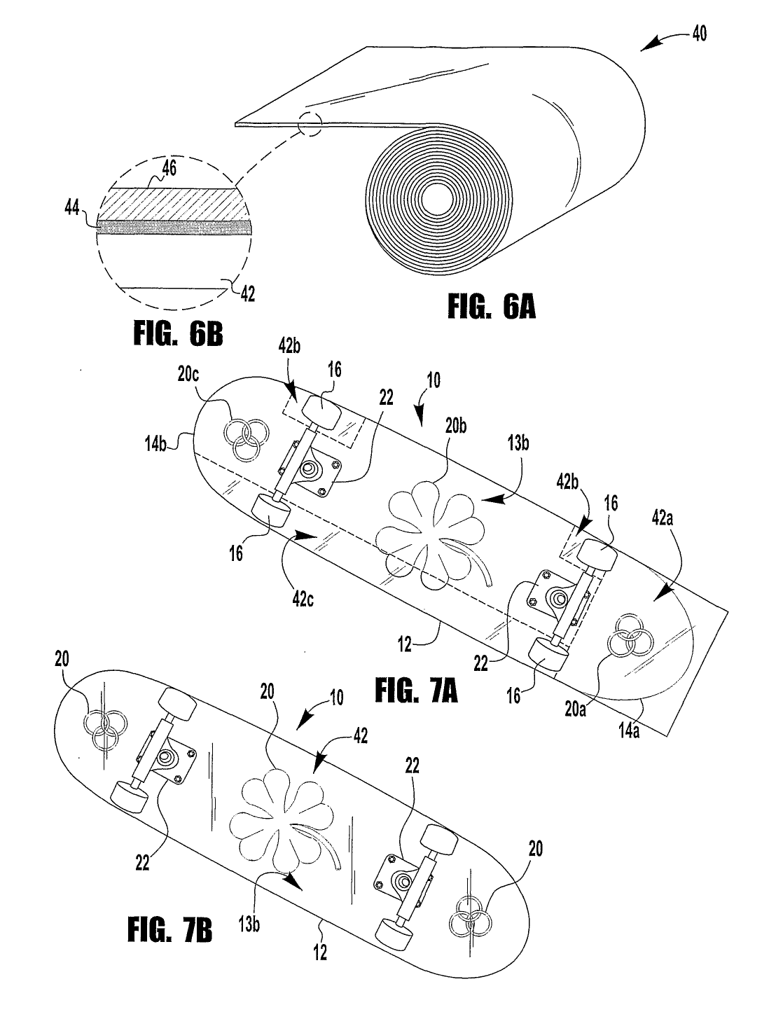

Practice of the invention will now be described with reference to FIGS. 6A, 6B, 7A and 7B. The plastic 42 can be supplied in various convenient forms such as, for example, large sheets (e.g., the size of a skateboard deck 12), pre-cut pieces, and cut-to length strips. FIG. 6A shows material 40 as supplied in a convenient roll. For handling purposes, the plastic is supplied as a multilayer material 40 that is shown magnified in FIG. 6B, which comprises a layer of the plastic 42 (e.g., 0.020 inch, 0.51 mm thick), a layer of adhesive 44 (e.g., 0.005 inch, 0.13 mm thick), and a removable layer of liner paper 46 (e.g., 0.012 inch, 0.30 mm thick). By unrolling the multilayer material 40 and cutting off the desired length, then peeling off the liner paper 46, a piece of plastic sheet (e.g., a nose-covering piece 42a) can be self-adhered to the bottom surface 13b of the deck 12, protectively covering the nose graphic 20a, and enhancing the sliding characteristics of the entire nose portion 14a of the board 10 from the truck 22 forward. Once applied, the plastic 42 that extends beyond the edges of the deck 12 can be easily trimmed off, for example with a knife, or for example, the material 40 can be marked with a pencil on the liner paper 46 and cut to shape before the liner paper 46 is removed. In an alternative embodiment, the material 40 can be provided to the user as a pre-cut piece. After application, the nose-covering piece 42a will protect the deck 12 and graphic 20a when the board 10 is used for sliding along a wall 102 as shown in FIG. 2. In addition to abrasion protection, the plastic 42 also greatly enhances lubrication to enable much longer slides, and furthermore produces a consistent amount of lubrication so that repeated slides will be predictably consistent. This is because the high density plastic is so resistant to wear that it changes very little over the course of many slides. Finally, if a clear plastic and adhesive are used as preferred, then the protected graphic 20a is still visible.

Many other forms of application of the plastic sheet material 42 will be apparent given the teaching of this disclosure, some examples of which are also shown in FIGS. 7A-7B. For example, a long strip of material 42c can be applied to the bottom 13b along the edge of the deck 12 (e.g., a 1 inch, 25 mm wide “tape”). If applied along both edges, then the plastic strip(s) 42c will protect the board during slides anywhere on the bottom surface 13b of the deck 12, e.g., in the middle between trucks 22 as shown in FIG. 3. Furthermore, since the plastic strip 42c is located between the wheels 16 and the deck 12, the plastic 42 will lubricate any rubbing contact (e.g., at location 200 in FIG. 5) thereby minimizing “wheel bite”. In another example, small plastic patches 42b can be applied only where needed to minimize “wheel bite”.

FIG. 7B illustrates another example which is a preferred embodiment, wherein the plastic 42 is adhered to the entire bottom surface 13b of the deck 12 and the wheel trucks 22 are then screw attached to the deck 12 with the plastic 42 sandwiched between the bottom surface 13b and the truck 22. Preferably a clear plastic 42 with a clear (transparent) adhesive 44 is used and the graphics 20 are already applied to the bottom surface 13b. Also preferably the adhesive 44 is a resilient composition, and the plastic sheet 42 is UHMW plastic that is 0.005-0.030 inch (0.13-0.76 mm) thick, most preferably about 0.020 inch (0.51 mm) thick. In actual-use testing it has been found that a skateboard 10 assembled this way exhibited additional advantages of extra “pop”, and improved resistance to delamination of the wood layers in the deck 12. Even further, there was a reduced tendency to cracking and breakage of the deck 12 at the truck 22 edges and at the holes made by the truck mounting screws.

Applying the graphics 20 to the adhesive side of the plastic sheet 42 is one possible improvement to this invention. A graphic 20 could even have a thin layer of electroluminescent material in it to add light-up abilities to the graphic 20 and the board 10.

Trucks

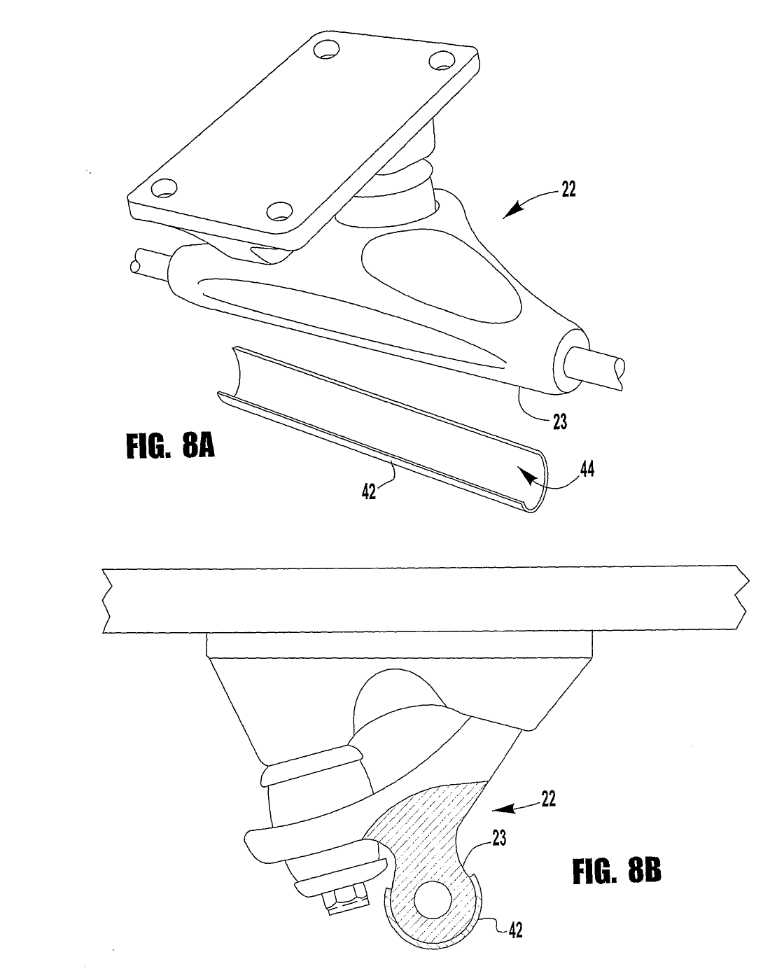

Just as deck 12 surfaces 13 are being used to slide, the trucks 22 are used for grinding. Likewise, just as the inventive self-adhering, high performance plastic 42 both protects the deck 12 and enhances the deck's sliding properties, so the invention can be used to protect the truck 22 and enhance the truck's grinding properties. As illustrated in FIGS. 8A and 8B, a piece of the plastic 42 is pre-cut to a suitable size, the liner paper (46, not shown) is peeled off to expose the adhesive 44, and the plastic 42 is then self-adhered to the bottom, axle-holding, “hanger” portion 23 of the truck 22. Since the plastic 42 is relatively thin, and since the adhesive 44 is an aggressive, high tack adhesive, the plastic 42 can be quickly and easily adhered to the bottom 23 of the truck 22, even if non-linear, complex shapes are involved. For example, the plastic sheet 42 can be adhered to a complex surface in a way that might create folds, but the folds are easily trimmed with, for example, a razor blade.

The addition of the inventive self-adhering plastic 42 on the truck 22 provides a more desirable sliding (“grinding”) performance—enabling longer grinds and more consistent or repeatable grinding—as well as protecting the truck 22 with a lower cost replacement part (the plastic 42) which is easily and quickly installed and replaced.

An alternative embodiment of the inventive use of high performance plastic (e.g., UHMW) is a truck hanger 23 that is made entirely of a plastic that demonstrates the best properties for grinding, wear resistance, and aesthetics.

Related Sports Equipment

Since the inventive self-adhering high performance plastic sheet material 42 provides such exciting performance improvements for skateboards 10, many other sports equipment applications become obvious candidates for use of the invention—a criterion being that a surface of the equipment not originally intended for such use can be used for sliding on another surface, thereby adding new dimensions to the use of the sports equipment, particularly if friction and wear can be significantly reduced. A secondary criterion is a desire for a surface enhancement that can easily and creatively be implemented by an end user of the sports equipment.

A first example of invention use on a related item of sports equipment is shown in FIG. 9, wherein the sole 32 (i.e., the bottom surface) of a skate boot 30 can be covered with a layer of self-adhered plastic 42. One side of the sole 32 is shown covered by a rectangular piece of the plastic 42b, which can be trimmed to look like the custom shaped piece of plastic 42a shown on the other side of the sole 32. In the middle of the sole 32 a set of in-line skate wheels 34 is mounted between two support rails 36 that are attached to the in-line skate boot sole 32. The rails 36 are analogous to the truck 22 on a skateboard 10, therefore plastic strips 42c, 42d applied across the rails/truck 36 between wheels 34 will enhance “grinding” performance on the inline skate 30.

Two other examples out of many possible implementations of the inventive self-adhering plastic 42 are shown in the remaining Figures. These embodiments were inspired by the spontaneously creative nature of the invention.

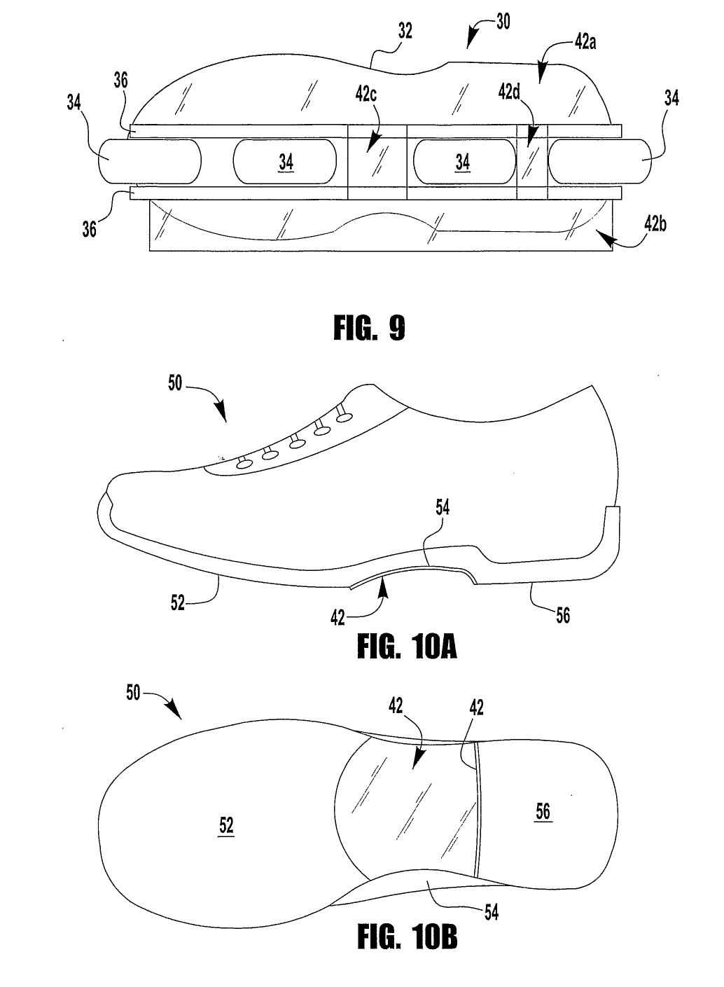

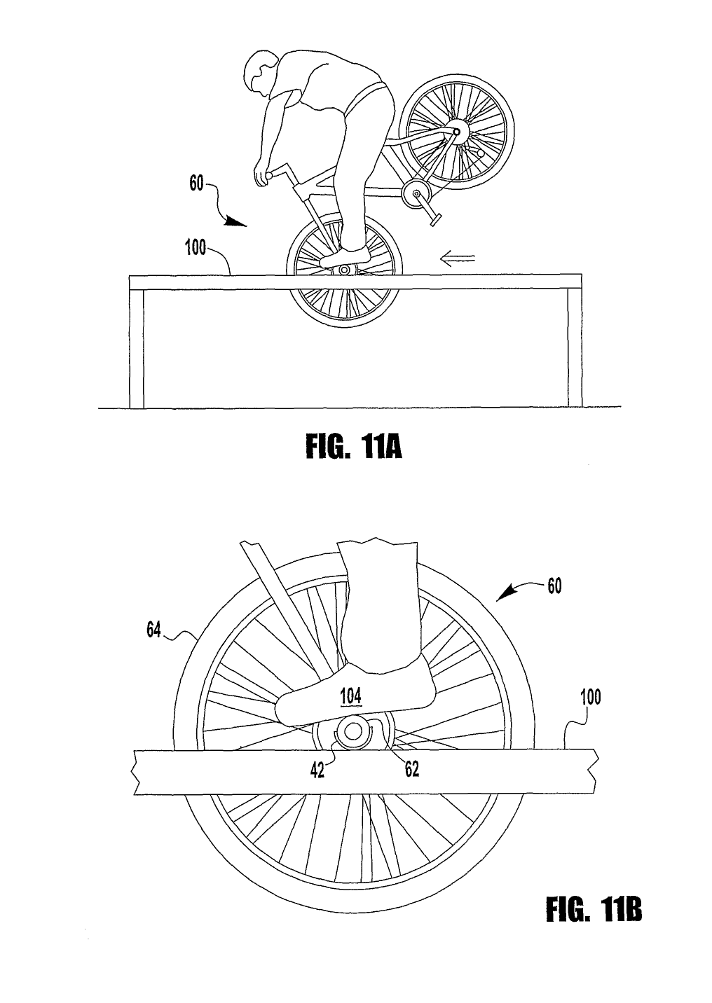

FIGS. 10A-10B show a common shoe 50 that has been enhanced by adhering the plastic 42 to the arched (recessed) portion 54 of the shoe's sole 52. The plastic 42 is also adhered to the leading edge of the heel 56, thereby providing a groove that is very slippery while not affecting the ground-contacting portion of the sole 52. Thus the shoe wearer can walk normally without slipping, but can easily slide sideways on a raised surface of suitable width such as, for example, a rail 100.

FIGS. 11A-11B show a stunt bike 60 (e.g., a BMX bike) that has been enhanced by adhering the plastic 42 to at least a portion of the surface of a peg 62 that extends from the bike frame, e.g., at the center of the wheel 64. The peg 62 is generally provided on such bikes so that the rider has another place to stand besides the pedals. By adhering the plastic 42 to only the bottom portion of the peg 62 the rider still has a non-slip surface on which to place his foot 104.

### CONCLUSION

High performance plastics provide many advantages over metal or lubricant coatings for improved sliding, grinding, wear protection and weight reduction. They enhance the everyday skater's ability and enjoyment, and they add a competitive advantage to the professional's arsenal. The present invention is a novel configuration of these plastics that makes it fast, simple and inexpensive to apply a high performance plastic layer on virtually any surface that the user wants to add slip and protection. The uses are thus limited only by the creativity of the user.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

1-8. (canceled)

9. A method for enhancing sliding performance of sports equipment surfaces, the method comprising the steps of:
providing a wear resistant, low friction plastic material in the form of a relatively thin and flexible sheet;
supplying a resilient, aggressive, high-tack adhesive layer on a surface of the sheet material; and
adhering the sheet to one of the group of sports equipment surfaces consisting of: the portion of a skateboard deck bottom surface located under a wheel a hanger portion of a wheel truck the sole of a skate boot rails between skate wheels a shoe sole, and a post of a cycle.

10. The method of claim 9, wherein:
the plastic is UHMW plastic.

11. The method of claim 9, wherein:
the plastic and the adhesive are substantially transparent.

12. The method of claim 9, wherein:
the plastic is 0.005 to 0.030 inch (0.13-0.76 mm) thick.

13. The method of claim 9, wherein:
the plastic is about 0.020 inch (0.51 mm) thick.

14. The method of claim 9, wherein:
the plastic layer incorporates graphics.

15. A method for enhancing performance of sports equipment that comprises a board-like member, the method comprising the steps of:
providing a long chain, high density polymeric plastic material in the form of a relatively thin and flexible sheet;
applying a resilient, aggressive, high-tack adhesive layer on a surface of the sheet; and
enhancing the springiness of the board-like member by adhering the sheet onto substantially all of a surface of the board-like member.

16. The method of claim 15, wherein:
the long chain, high density polymeric plastic is UHMW plastic.

17. The method of claim 15, wherein:
the adhesive is rubber based.

18. The method of claim 15, wherein:
the board-like member is comprised of laminated layers, at least one of which is wood.

19. The method of claim 15, wherein:
the sports equipment is a skateboard.

20. The method of claim 15, wherein:
the plastic and the adhesive are substantially transparent.

21. The method of claim 15, wherein:
the plastic is 0.005 to 0.030 inch (0.13-0.76 mm) thick.

22. The method of claim 15, wherein:
the plastic is about 0.020 inch (0.51 mm) thick.

23. The method of claim 15, wherein:
the plastic layer incorporates graphics.
